(19) United States
(12) Patent Application Publication
(10) Pub. No.: US 2026/0129701 A1
(43) Pub. Date: May 7, 2026

(54) Synchronized Transmission System and Method for Dual-Source Wireless Audio

(71) Applicant: Zgmicro Wuxi Corporation, Wuxi (CN)

(72) Inventors: Bin Xu, Wuxi (CN); David Xiaodong Yang, Wuxi (CN)

(73) Assignee: Zgmicro Wuxi Corporation, Wuxi (CN)

(21) Appl. No.: 19/375,189

(22) Filed: Oct. 30, 2025

(30) Foreign Application Priority Data
Nov. 6, 2024 (CN) 2024115751098

(51) Int. Cl. H04W 76/15; G06F 3/16; H04W 4/80

(52) U.S. Cl. CPC H04W 76/15; G06F 3/162; H04W 4/80

(57) ABSTRACT

The present disclosure discloses a synchronized transmission system and method for dual-source wireless audio. The system comprises an audio device, a first audio source device, and a second audio source device. The audio device comprises a host processor and a plurality of controllers. The first audio source device establishes a first communication link with a first controller among the plurality of controllers to perform audio data transmission for a first audio stream; the second audio source device establishes a second communication link with a second controller among the plurality of controllers to perform audio data transmission for a second audio stream.

### CROSS-REFERENCE OF RELATED APPLICATIONS

The present disclosure claims priority of Chinese Patent Application No. 2024115751098 filed in China on Nov. 6, 2024, the entire contents of which is incorporated herein by reference.

### FIELD OF THE INVENTION

The present disclosure relates to the field of wireless audio transmission technologies, and specifically to a synchronized transmission system and method for dual-source wireless audio.

### BACKGROUND

The rapid development of wireless connection technologies such as Classic Bluetooth (CBT), Bluetooth Low Energy (BLE), and Wireless Fidelity (WIFI) has made wireless audio and wireless calls an important part of people's lives. For example, CBT wireless audio terminal devices that use smartphones as audio source devices, such as CBT Audio headphones and CBT Audio speakers, are widely popular among people. BLE Audio, which offers lower latency, lower power consumption, and higher performance for wireless audio services, is also expected to receive increasing attention.

However, conventional CBT Audio or BLE Audio terminal devices can only connect to one CBT or BLE audio source device to transmit and receive wireless audio, and do not support connecting to two or more CBT or BLE audio source devices to simultaneously transmit and receive wireless audio. For example, existing CBT or BLE Audio headphones cannot use one smartphone for an online meeting while simultaneously using another smartphone to make or receive a phone call. Similarly, they cannot use one smartphone for low-latency gaming while simultaneously using another smartphone for calls. In other words, conventional CBT or BLE wireless audio terminal devices are incapable of connecting to two or more CBT or BLE audio source devices to simultaneously transmit and receive wireless audio. In other words, they do not support Dual-Source Wireless Audio (DSWA) or Multi-Source Wireless Audio (MSWA).

### SUMMARY

In view of this, the present disclosure provides a synchronized transmission system and method for dual-source wireless audio to solve the current problem that synchronized transmission of dual-source wireless audio cannot be achieved.

In a first aspect, a synchronized transmission system for dual-source wireless audio is provided. The system comprises: an audio device, comprising a host processor and a plurality of controllers; a first audio source device configured for establishing a first communication link with a first controller among the plurality of controllers to perform audio data transmission for a first audio stream with the audio device based on the first communication link; and a second audio source device configured for establishing a second communication link with a second controller among the plurality of controllers to perform audio data transmission for a second audio stream with the audio device based on the second communication link; wherein when the audio data transmission on the first communication link and the audio data transmission on the second communication link coexist, frequency division multiplexing is adopted between the first communication link and the second communication link, and a transmission time of either one of the first communication link and the second communication link does not overlap with a reception time of the other of the first communication link and the second communication link.

In a second aspect, a synchronized transmission method for dual-source wireless audio is provided. The method is applied to an audio device comprising a host processor and a plurality of controllers. The method comprises: establishing a first communication link with a first audio source device using a first controller among the plurality of controllers, and performing audio data transmission for a first audio stream with the first audio source device based on the first communication link; and establishing a second communication link with a second audio source device using a second controller among the plurality of controllers, and performing audio data transmission for a second audio stream with the second audio source device based on the second communication link. When the audio data transmission on the first communication link and the audio data transmission on the second communication link coexist, frequency division multiplexing is adopted between the first communication link and the second communication link, and a transmission time of either one of the first communication link and the second communication link does not overlap with a reception time of the other of the first communication link and the second communication link.

In a third aspect, an audio device is provided. The audio device comprises: a host processor; a first controller configured for establishing a first communication link with a first audio source device, so as to perform audio data transmission for a first audio stream with the first audio source device based on the first communication link; and a second controller configured for establishing a second communication link with a second audio source device, so as to perform audio data transmission for a second audio stream with the second audio source device based on the second communication link. When the audio data transmission on the first communication link and the audio data transmission on the second communication link coexist, frequency division multiplexing is adopted between the first communication link and the second communication link, and a transmission time of either one of the first communication link and the second communication link does not overlap with a reception time of the other of the first communication link and the second communication link.

There are many other objects, together with the foregoing attained in the exercise of the disclosure in the following description and resulting in the embodiment illustrated in the accompanying drawings.

### BRIEF DESCRIPTION OF THE DRAWINGS

These and other features, aspects, and advantages of the present disclosure will become better understood with regard to the following description, appended claims, and accompanying drawings wherein:

FIG. 1 is a schematic diagram of a system architecture of a synchronized transmission system for dual-source wireless audio according to one embodiment of the present disclosure;

FIG. 2 is a schematic flowchart of a synchronized transmission method for dual-source wireless audio according to one embodiment of the present disclosure;

FIG. 3 is a schematic timing diagram of a time relationship between dual links in the synchronized transmission method for dual-source wireless audio according to one embodiment of the present disclosure;

FIG. 4 is a schematic diagram of a series connection configuration of controllers within an audio device according to one embodiment of the present disclosure;

FIG. 5 is a schematic diagram of a parallel connection configuration of controllers within the audio device according to one embodiment of the present disclosure; and

FIG. 6 is a schematic diagram of a hardware structure of a computer device according to one embodiment of the present disclosure.

### DETAILED DESCRIPTION

The detailed description of the disclosure is presented largely in terms of procedures, operations, logic blocks, processing, and other symbolic representations that directly or indirectly resemble the operations of data processing devices that may or may not be coupled to networks. These process descriptions and representations are typically used by those skilled in the art to most effectively convey the substance of their work to others skilled in the art.

Reference herein to “one embodiment” or “an embodiment” means that a particular feature, structure, or characteristic described in connection with the embodiment can be comprised in at least one embodiment of the disclosure. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the disclosure do not inherently indicate any particular order nor imply any limitations in the disclosure.

To clarify the objectives, technical solutions, and advantages of the embodiments of the present disclosure, the technical solutions in the embodiments of the present disclosure will be clearly and completely described below in conjunction with the accompanying drawings in the embodiments of the present disclosure. Obviously, the described embodiments are part of the embodiments of the present disclosure, rather than all the embodiments. Based on the embodiments of the present disclosure, all other embodiments obtained by those skilled in the art without making creative efforts shall fall within the protection scope of the present disclosure.

CBT wireless audio terminal devices that use smartphones as audio source devices, such as CBT Audio headphones and CBT Audio speakers, are widely popular among people. BLE Audio provides wireless audio services with lower latency, lower power consumption, and higher performance, and will also attract more attention from people. However, existing CBT Audio or BLE Audio terminal devices can only connect to one CBT or BLE audio source device to transmit and receive wireless audio, and do not support connecting to two or more CBT or BLE audio source devices to simultaneously transmit and receive wireless audio. For example, existing CBT or BLE Audio headphones cannot be used to host an on-line meeting with one smartphone while making or receiving a call with another smartphone; nor can they be used to play a low-latency game with one smartphone while making or receiving a call with another smartphone. That is, CBT or BLE wireless audio terminal devices cannot connect to two or more CBT or BLE audio source devices to simultaneously transmit and receive wireless audio. In other words, they do not support Dual-Source Wireless Audio (DSWA) or Multi-Source Wireless Audio (MSWA).

A synchronized transmission method for dual-source wireless audio is provided according to one embodiment of the present disclosure. It should be noted that operations shown in a flowcharts in the accompanying drawings can be executed in a computer system, such as a set of computer-executable instructions. Although a logical order is shown in the flowcharts, in some cases, the operations shown or described can be executed in an order different from that herein.

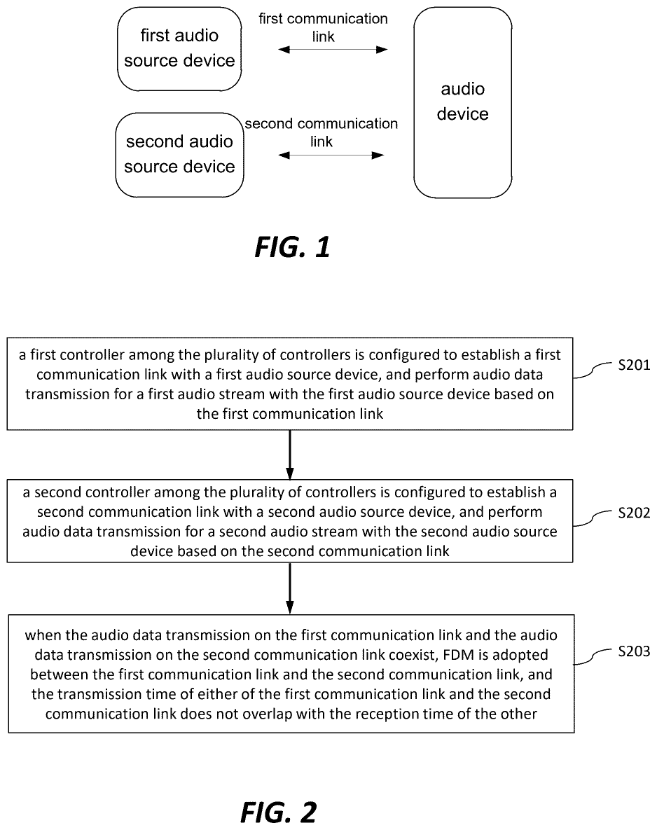

In one embodiment, a synchronized transmission system for dual-source wireless audio is provided. FIG. 1 is a schematic diagram of a system structure of the synchronized transmission system for dual-source wireless audio. The system comprises an audio device, a first audio source device, and a second audio source device. The audio device comprises a host processor and a plurality of controllers. The first audio source device establishes a first communication link with a first controller among the plurality of controllers, so as to perform audio data transmission for a first audio stream with the audio device based on the first communication link. The second audio source device establishes a second communication link with a second controller among the plurality of controllers, so as to perform audio data transmission for a second audio stream with the audio device based on the second communication link. When the audio data transmission on the first communication link and the audio data transmission on the second communication link coexist, frequency division multiplexing (FDM) is adopted between the first communication link and the second communication link, and a transmission time of either one of the first communication link and the second communication link does not overlap with a reception time of the other of the first communication link and the second communication link.

It is found that in the prior art, effective bandwidth for wireless transmission between a CBT or BLE wireless audio terminal device and two or more CBT or BLE audio source devices is insufficient, especially the effective bandwidth is insufficient due to mutual interference caused by overlapping of receiving and transmitting time, so that it is difficult to support DSWA or MSWA.

In one embodiment, the frequency division multiplexing between the first communication link and the second communication link can be understood as follows: the audio device communicates with each audio source device using different frequency channels respectively at the same time.

In one embodiment, “the transmission time of either one of the first communication link and the second communication link does not overlap with a reception time of the other of the first communication link and the second communication link” can be understood as follows: for the audio device, the transmission time of its first controller on the first communication link does not overlap with the reception time of its second controller on the second communication link; moreover, the reception time of the first controller on the first communication link does not overlap with the transmission time of the second controller on the second communication link. That is, during the period when the first controller transmits data packets to the first audio source device on the first communication link, the second controller will not perform the action of receiving data packets sent by the second audio source device on the second communication link, and vice versa. For any audio source device, during the period when it transmits data packets to the audio device, other audio source devices may or may not transmit data packets to the audio device, but will not perform the action of receiving data packets from the audio device.

Therefore, an audio device with a multi-controller structure is adopted in the present disclosure, and uses different controllers to establish communication links with different audio source devices respectively. The system controls the coexistence of the communication links by means of frequency division multiplexing. Furthermore, when configuring the transmission and reception time slots on each communication link, the system ensures that the transmission time of either of the first communication link and the second communication link does not overlap with the reception time of the other. Thus, while increasing the bandwidth, the system controls the transmission and reception times of each communication link to be relatively synchronized, and the transmission and reception signals of each audio source device and each controller of the audio device do not interfere with each other, enabling one audio device to support synchronized wireless audio transmission of at least two audio sources.

In specific implementation, the audio source device may be a mobile phone, a portable game console, a portable media player, a personal computer, a vehicle-mounted media player, an adapter (Dongle) for connecting to a multimedia device, etc. It can transmit an audio stream to the audio device, and the audio stream data may be locally stored or received from an external source, for example, locally stored audio data, call voice data streams received via a mobile cellular network, voice/audio data received via the Internet, etc. The first audio source device and the second audio source device may be the same type of device or different types of devices.

The audio device may be any type of audio output device used to convert the audio stream into an audio signal and play it, such as a speaker, in-ear headphones, over-ear headphones, a sound box, etc. In addition, the audio device may also have an audio input function, that is, it can not only receive an audio stream from the audio source device, but also collect a local sound signal and transmit it to the audio source device. For example, when a headset with a microphone is used for voice call functions, it can collect the voice signal of the headset user and transmit it to the mobile phone. For ease of understanding, a SDSWA (Synchronized Dual-Source Wireless Audio) headset with a microphone can be used as a specific example of the audio device for illustration. In the system shown in FIG. 1, the first audio source device may optionally be a smartphone, the second audio source device may optionally be a USB Dongle plugged into another smartphone, and the audio device is a SDSWA headset with a microphone. An exemplary application scenario is that the SDSWA headset connects to the smartphone via the first communication link for making/receiving calls, while simultaneously connecting to the USB Dongle via the second communication link for gaming.

The connection relationships between the audio device and the first audio source device as well as the second audio source device comprise three types: the first type is establishing only the first communication link with the first audio source device; the second type is establishing only the second communication link with the second audio source device; the third type is establishing the first communication link with the first audio source device and the second communication link with the second audio source device respectively, that is, the audio data transmission on the first communication link and the second communication link coexists.

The audio device comprises an Application & Host Processor and a Scalable Controller. The Scalable Controller comprises a plurality of controllers, and each controller can independently receive, send, and process audio data transmitted between the audio device and different audio source devices. That is, the first controller among the multiple controllers establishes the first communication link with the first audio source device to transmit the first audio stream, and the second controller among the multiple controllers establishes the second communication link with the second audio source device to transmit the second audio stream, thus realizing synchronized transmission and playback when two audio streams from different audio sources coexist.

It can be understood that both the first audio stream and the second audio stream may be unidirectional audio data streams or bidirectional audio data streams. That is, the audio device may only receive audio data from the audio source device. For example, when listening to music from a mobile phone through headphones, the transmission between the headphones and the mobile phone is a unidirectional audio stream. The audio device may also receive audio data from the audio source device and transmit audio data to the audio source device. For example, when making a call through headphones, the headphones not only receive call voice from the mobile phone, but also transmit the voice of the headset user to the mobile phone. In this case, the transmission between the headphones and the mobile phone is a bidirectional audio stream.

In some optional embodiments, the first audio source device serves as the central device of the first communication link, the audio device serves as the peripheral device of the first communication link, and the first link clock of the first communication link is the same as or synchronized with the local clock of the first audio source device; the second audio source device serves as the peripheral device of the second communication link, the audio device serves as the central device of the second communication link, and the second link clock of the second communication link is the same as or synchronized with the first link clock.

It is found that in the prior art, the asynchrony of the clocks of CBT links or BLE links between a CBT or BLE wireless audio terminal device and two or more CBT or BLE audio source devices may also affect the synchronized collection, synchronized transmission, and synchronized playback of DSWA or MSWA in the system. In one embodiment, one of the audio source devices is used as the central device of one communication link, and the audio device is used as the central device of the other communication link. By changing the role of the audio device in different communication links, the clocks of the communication links established between the audio device and the two audio source devices are synchronized (also referred to as “synchronized dual audio sources”). Therefore, this not only avoids the overlap between the transmission time of one link and the reception time of the other link caused by the relative clock drift of the two links, but also facilitates the synchronization of audio collection, transmission, and playback in the dual-source system.

For example, in the above application scenario, the SDSWA headset connects to the first audio source device via the first communication link, wherein the SDSWA headset serves as the peripheral device of the first communication link and the first audio source device serves as the central device of the first communication link. At the same time, the SDSWA headset connects to the second audio source device via the second communication link, wherein the SDSWA headset serves as the central device of the second communication link and the second audio source device serves as the peripheral device of the second communication link.

In some optional embodiments, when the second audio source device serves as the peripheral device of the second communication link, the local clock of the second audio source device is adjusted based on the second link clock of the second communication link, so that the adjusted local clock of the second audio source device is the same as or synchronized with the second link clock.

In other optional embodiments, the second audio source device may further be provided with an asynchronous Sampling Rate converter (ASRC), which is used to synchronize a sampling rate of the audio data input to the second audio source device with the adjusted local clock of the second audio source device.

For example, in the above application scenario, when the SDSWA headset is connected to both the first audio source device and the second audio source device at the same time, two situations may occur: the first situation is connecting to the first audio source device first and then to the second audio source device; the second situation is connecting to the second audio source device first and then to the first audio source device.

For the first situation, the first communication link is established first, wherein the first audio source device serves as the central device of the first communication link and the SDSWA headset serves as the peripheral device of the first communication link. The first link clock of the first communication link is configured by the first audio source device using its local clock.

The SDSWA headset continuously adjusts a Numerically Controlled Oscillator (NCO) of its local clock according to the difference between its local clock and the first link clock, so that the local clock of the SDSWA headset is the same as or synchronized with the first link clock of the first communication link or the first audio source device.

When connecting to the second audio source device, the SDSWA headset uses its adjusted local clock according to the first communication link to establish the second communication link, and the second link clock is the same as or synchronized with the adjusted local clock of the SDSWA headset according to the first communication link. The second audio source device (USB Dongle) adjusts the NCO of its local clock according to the difference between its local clock and the second link clock, so that the local clock of the USB Dongle is the same as or synchronized with the second link clock and thus the local clock of the USB Dongle is the same as or synchronized with the first link clock.

If the USB Dongle is connected first and then the first audio source device is connected, the second communication link is established first. The SDSWA headset serves as the central device of the second communication link, and the USB Dongle serves as the peripheral device of the second communication link. The SDSWA headset configures the second link clock of the second communication link according to its local clock. The USB Dongle adjusts the NCO of its local clock according to the difference between its local clock and the second link clock, so that the local clock of the USB Dongle is the same as or synchronized with the second link clock.

In this application scenario, frequency division multiplexing is adopted between the first communication link and the second communication link, transmission and reception time slots do not overlap with each other, and the clock synchronization of the entire system is controlled. This approach not only solves the bandwidth problem of dual-source transmission, but also solves the problems of mutual interference in dual-source transmission and synchronized audio input/output playback, and can effectively support dual-source wireless audio.

In one embodiment, a synchronized transmission method for dual-source wireless audio is provided, which is applied to an audio device. The audio device comprises a host processor and a plurality of controllers. FIG. 2 is a flowchart of the synchronized transmission method for dual-source wireless audio according to one embodiment of the present disclosure. As shown in FIG. 2, the method comprises the following operations.

At S201: a first controller among the plurality of controllers is configured to establish a first communication link with a first audio source device, and perform audio data transmission for a first audio stream with the first audio source device based on the first communication link.

Specifically, the first controller identifies the first audio source device and establishes the first communication link with it. The first controller can perform unidirectional or bidirectional audio data transmission with the first audio source device through the first communication link.

At S202: a second controller among the plurality of controllers is configured to establish a second communication link with a second audio source device, and perform audio data transmission for a second audio stream with the second audio source device based on the second communication link.

At S203: when the audio data transmission on the first communication link and the audio data transmission on the second communication link coexist, frequency division multiplexing (FDM) is adopted between the first communication link and the second communication link, and the transmission time of either of the first communication link and the second communication link does not overlap with the reception time of the other.

It should be understood that the timing relationship between S101 and S102 may be flexible, and is not limited to the order shown in FIG. 2.

Specifically, inside the audio device, the host processor and the plurality of controllers are configured to support frequency division multiplexing, and a frequency channel different from that of the first communication link is allocated to the second communication link.

In addition, according to protocol characteristics of the first communication link and the second communication link, various parameters such as sampling rate, coding rate, inter-packet interval duration, and offset between start points of the first communication link and the second communication link can be adjusted to configure that the transmission time of either of the first communication link and the second communication link does not overlap with the reception time of the other. This ensures that the audio data transmission on the two communication links is parallel and does not interfere with each other.

In some optional embodiments, the first audio source device serves as the central device of the first communication link, the audio device serves as the peripheral device of the first communication link, and the first link clock of the first communication link is the same as or synchronized with the local clock of the first audio source device. The second audio source device serves as the peripheral device of the second communication link, the audio device serves as the central device of the second communication link, and the second link clock of the second communication link is the same as or synchronized with the first link clock.

In some optional embodiments, the method further comprises: when communicating with the first audio source device, acquiring the first link clock of the first communication link, and adjusting the local clock adopted by the first controller based on the first link clock, so that the adjusted local clock adopted by the first controller is the same as or synchronized with the first link clock; when communicating with the second audio source device, establishing or maintaining the second link clock of the second communication link according to the adjusted local clock adopted by the first controller, so that the second link clock is the same as or synchronized with the adjusted local clock adopted by the first controller.

Since the audio device in one embodiment has a multi-controller structure and uses the first controller to work on the first communication link, when communicating with the first audio source device, the audio device needs to continuously adjust the Numerically Controlled Oscillator (NCO) of the local clock adopted by the first controller according to the difference between the local clock adopted by the first controller and the first link clock. This ensures that the local clock adopted by the first controller is the same as or synchronized with the first link clock. Thus, when the second controller serving as the central device of the second communication link communicates with the second audio source device, the second controller establishes or maintains the second link clock of the second communication link according to the adjusted local clock adopted by the first controller. Because the local clock adopted by the first controller is adjusted following the first link clock, this adjustment can be conducted to the second link clock, so that the second link clock of the second communication link is the same as or synchronized with the first link clock.

In some optional embodiments, the local clock adopted by the first controller is different from the local clock adopted by the second controller. Therefore, when communicating with the second audio source device, the operation of establishing or maintaining the second link clock of the second communication link according to the adjusted local clock adopted by the first controller (so that the second link clock is the same as or synchronized with the adjusted local clock adopted by the first controller) comprises: adjusting the local clock adopted by the second controller according to the adjusted local clock adopted by the first controller, so that the adjusted local clock adopted by the second controller is the same as or synchronized with the adjusted local clock adopted by the first controller; and establishing or maintaining the second link clock of the second communication link according to the adjusted local clock adopted by the second controller.

In other optional embodiments, the first controller and the second controller adopt the same local clock. Therefore, when communicating with the second audio source device, the operation of establishing or maintaining the second link clock of the second communication link according to the adjusted local clock adopted by the first controller (so that the second link clock is the same as or synchronized with the adjusted local clock adopted by the first controller) comprises: the second controller establishes or maintains the second link clock of the second communication link according to the adjusted local clock.

It should be understood that the system and method of the present application can also be applied to the synchronized transmission of Multi-Source Wireless Audio (MSWA). Among them, multiple controllers in the audio device can be enabled to establish different communication links with different audio source devices respectively. The first audio source device is defined as the main audio source device, which serves as the central device of the first communication link, and the audio device serves as the peripheral device of the first communication link. Other audio source devices can all serve as slave audio source devices; the audio device serves as the central devices on the communication links of the slave audio source devices, and the slave audio source device serves as the peripheral devices. Thus, the link clock of all communication links is the same as or synchronized with the local clock of the main audio source device.

In some optional embodiments, the first communication link is a Classic Bluetooth (CBT) link, and the second communication link uses a different link protocol than the first communication link. The second communication link may adopt the Bluetooth Low Energy (BLE) link protocol or other link protocols suitable for this embodiment. These link protocols may be general standard protocols or custom private protocols.

In one optional embodiment, the first communication link is a CBT link, and the second communication link is a BLE link.

For example, in the system shown in FIG. 1, the first audio source device may optionally be a smartphone, the second audio source device may optionally be a USB Dongle plugged into another smartphone, and the audio device is a SDSWA headset with a microphone. The first audio source device is used as the main audio source device, and the second audio source device is used as the slave audio source device. The SDSWA headset has a scalable controller, which comprises a primary controller and at least one secondary controller.

The SDSWA headset connects to the main audio source device via the CBT link, where the SDSWA headset serves as the peripheral device of the CBT link and the main audio source device serves as the central device of the CBT link. The SDSWA headset connects to the slave audio source device via the BLE link, where the SDSWA headset serves as the central device of the BLE link and the slave audio source device serves as the peripheral device of the BLE link.

When the CBT link and the BLE link coexist, the SDSWA headset establishes and maintains the CBT link or the BLE link through the primary controller or the secondary controller respectively.

When the CBT link and the BLE link exist independently, the SDSWA headset establishes and maintains the CBT link or the BLE link through any one of the primary controller or the secondary controller.

An application scenario of this embodiment is that the SDSWA headset connects to a smartphone via the CBT link for making/receiving calls, while simultaneously connecting to the USB Dongle via the BLE link for gaming (where the game audio is bidirectional low-latency audio).

When the CBT link exists independently (i.e., the SDSWA headset connects to the main audio source device only through the first communication link), it can first establish a CBT asynchronous connection-oriented (ACL) link with the main audio source device. When a call is needed, it then establishes a CBT Extended Synchronous Connection-Oriented (eSCO) link, and subsequently establishes an upper-layer Hands-Free Profile (HFP) application. The main audio source device serves as the central device of the CBT link, and the SDSWA headset serves as the peripheral device of the CBT link. The SDSWA headset continuously adjusts the NCO of its local clock according to the difference between its local clock and the clock of the CBT link or the main audio source device, so that the local clock of the SDSWA headset is the same as or synchronized with the clock of the CBT link or the main audio source device.

When the BLE link exists independently (i.e., the SDSWA headset connects to the slave audio source device only through the second communication link), it first establishes a BLE ACL link. When gaming is needed, it then establishes a Connected Isochronous Group (CIG) link, and subsequently establishes an upper-layer Telephony and Media Audio Profile (TMAP) application. The SDSWA headset serves as the central device of the BLE link, and the USB Dongle serves as the peripheral device of the BLE link. The USB Dongle adjusts the NCO of its local clock according to the difference between its local clock and the clock of the BLE link or the SDSWA headphone, so that the local clock of the USB Dongle is the same as or synchronized with the clock of the BLE link or the SDSWA headphone.

When the CBT link and the BLE link coexist (i.e., the SDSWA headset is connected to both the main audio source device and the slave audio source device simultaneously), if the main audio source device is connected first and then the slave audio source device is connected, the clock relationship when connecting to the main audio source device is the same as that when connecting to the main audio source device independently. When connecting to the slave audio source device, the SDSWA headset uses its local clock adjusted according to the CBT link to establish the BLE link, and the clock of the BLE link is the same as or synchronized with the local clock of the SDSWA headset adjusted according to the CBT link. The USB Dongle adjusts the NCO of its local clock according to the difference between its local clock and the clock of the BLE link, so that the local clock of the USB Dongle is the same as or synchronized with the clock of the BLE link and thus the local clock of the USB Dongle is the same as or synchronized with the clock of the CBT link.

If the slave audio source device is connected first and then the main audio source device is connected, the clock relationship when connecting to the slave audio source device is the same as that when connecting to the slave audio source device independently. When connecting to the main audio source device, the SDSWA headset adjusts its local clock again according to the CBT link, and the clock of the BLE link is the same as or synchronized with the local clock of the SDSWA headset adjusted according to the CBT link. The USB Dongle adjusts the NCO of its local clock according to the difference between its local clock and the clock of the BLE link, so that the local clock of the USB Dongle is the same as or synchronized with the clock of the BLE link and thus the local clock of the USB Dongle is the same as or synchronized with the clock of the CBT link.

In addition, when the SDSWA headset disconnects from the main audio source device and the slave audio source device, if the slave audio source device is disconnected first and then the main audio source device is disconnected, after the BLE link is disconnected, the clock relationship between the SDSWA headset and the main audio source device is the same as that when connecting to the main audio source device independently.

If the main audio source device is disconnected first and then the slave audio source device is disconnected, after the CBT link is disconnected, the SDSWA headset stops adjusting its local clock according to the CBT link. The clock relationship between the SDSWA headset and the slave audio source device is similar to that when connecting to the slave audio source device independently, with the difference that the local clock adjusted according to the CBT link previously is no longer adjusted continuously.

When the SDSWA headset connects to the slave audio source device via the BLE link, and another smartphone transmits USB Audio through the USB Dongle, the external input clock of the USB Audio may be inconsistent with the local clock of the USB Dongle. Therefore, the USB Audio needs to undergo Sampling Rate conversion before being transmitted and received via the BLE link. At this time, the USB Audio uses an Asynchronous Sampling Rate Converter (ASRC) to perform Sampling Rate conversion according to the deviation between the local clock of the USB Dongle (estimated by the USB Dongle) and the external input clock, and then transmits and receives the converted USB Audio via the BLE link.

In one optional embodiment, the CBT link comprises a CBT eSCO link, which uses the 2EV3 packet type; the BLE link comprises a BLE CIG link, a sub-event interval of the BLE CIG link is equal to 1.25 ms, and an airtime occupied for transmitting one audio data packet is less than 858 μs.

Currently, almost all smartphones use the 2EV3 packet type when establishing an eSCO link for the HFP function. The 2EV3 packet has a payload of 60 bytes and occupies an airtime of 392 μs. Each slot of the CBT link is 625 μs. Each of the central device and the peripheral device of the CBT link transmit and receive the 2EV3 packet at least once, occupying one slot respectively, totaling 1.25 ms. With 2-3 retransmissions, the maximum occupied time may be 3.75 ms or 5 ms. After transmitting a 2EV3 packet in each slot, the peripheral device in the CBT link has 233μs of idle time, and the maximum time from the end of the previous 2EV3 packet transmission to the start of the next 2EV3 packet transmission is 858 μs. Moreover, after almost all smartphones establish the eSCO link, the packet types transmitted and received by the CBT ACL link maintained simultaneously are limited to one slot, and the occupied airtime is less than 392 μs (the airtime of the 2EV3 packet). Therefore, when the airtime occupied by the SDSWA headset for receiving audio data packets via the BLE CIG link is less than 858 μs, it can be ensured that the reception time does not overlap with the transmission time slot of the 2EV3 packet on the CBT link, thereby avoiding mutual interference. Similarly, after the peripheral device of the CBT link receives the 2EV3 packet in each slot, there is 233 μs of idle time, and the maximum time from the end of the previous 2EV3 packet reception to the start of the next 2EV3 packet reception is 858 μs. Therefore, when the airtime occupied by the SDSWA headset for sending audio data packets via the BLE CIG link is less than 858 μs, it can be ensured that the transmission time does not overlap with the reception time slot of the 2EV3 packet on the CBT link, thereby avoiding mutual interference.

It can be seen that when the sub-event interval of the BLE CIG link of the SDSWA headset is equal to 1.25 ms and the airtime occupied for transmitting one audio data packet does not exceed 858 μs, mutual interference with the CBT link can be effectively avoided.

For example, various system parameters of the above typical application scenario can be configured as follows: an isochronous interval (ISO Interval) is 5 ms, and a Low Complexity Communication Codec Plus (LC3 Plus) is adopted. For the central device of the BLE CIG link (i.e., the SDSWA headphone), a sampling rate of a mono microphone of the SDSWA headphone is 32 kHz, and a coding rate is 80 kbps. For the peripheral device of the BLE CIG link (i.e., the USB Dongle), the sampling rate of the stereo audio is 48 kHz, and the coding rate of each channel is 120 kbps. The size of a mono Service Data Unit (SDU) sent by the central device is 50 bytes, and the size of a stereo SDU sent by the peripheral device is 150 bytes. The BLE CIG comprises one Connected Isochronous Stream (CIS) link, which adopts a BLE 2 Mbps Physical Layer (PHY). The airtime occupied by a CIS Protocol Data Unit (PDU) sent by the central device is 260 μs, and the airtime occupied by the CIS PDU sent by the peripheral device is 660 μs. The Sub_Interval of the CIS link is equal to 1.25 ms, where a Time of Inter Frame Space (T_IFS) is 150 μs, and a Time of Minimum Slot Space (T_MSS) is 180 μs (if the microphone adopts a lower sampling rate, such as 24 kHz or 16 kHz, the CIS PDU occupies less airtime, and the T_MSS can be increased to 230 μs or 280 μs to ensure that the sub-interval is at least 1.25 ms). Within the 5 ms isochronous interval, there are at most 4 sub-events, i.e., the Number of Sub-Event (NSE) is 4. The connection interval of the BLE ACL link is 20 ms, and the maximum time occupied for transmission and reception within each connection interval is 1.25 ms. The CIS Offset (offset of the CIS link relative to the BLE ACL link) is equal to 1.25 ms. Therefore, the transmission and reception time of the BLE ACL link within each connection interval overlaps with the 4th CIS Sub-event in one of every 4 isochronous intervals of the CIS link, i.e., during the 3rd retransmission of the CIS PDU within that isochronous interval, the transmission and reception time of the BLE ACL link is occupied. To ensure the performance of BLE Audio, when the transmission and reception time of the BLE ACL overlaps with the retransmission time of the BLE CIG, the BLE CIG has priority.

Optionally, the CBT eSCO link may also use the 2EV5 packet type.

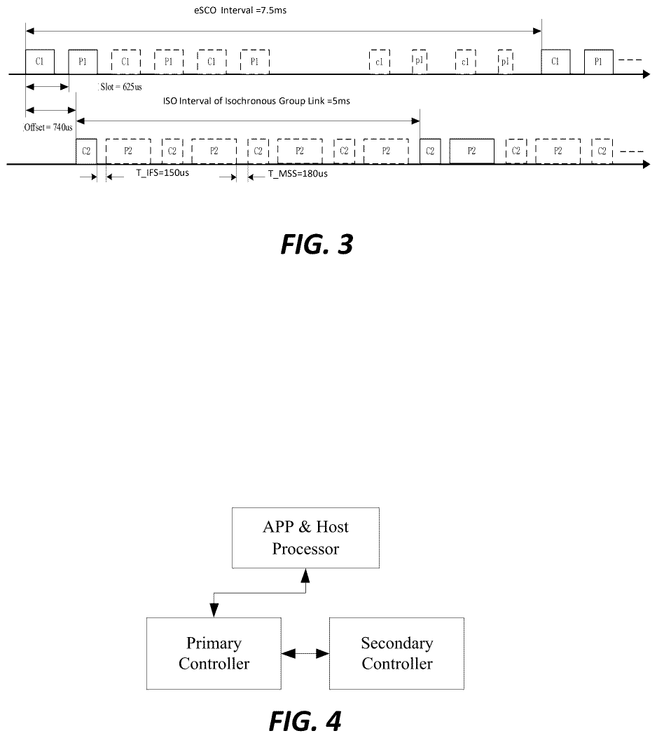

As shown in FIG. 3, which is a diagram illustrating the time coexistence relationship between the BLE link for the TMAP application and the CBT link for the HFP application: the interval (eSCO Interval) of the Extended Synchronous Connection-Oriented (eSCO) link is 7.5 ms, the isochronous interval of the Connected Isochronous Group (CIG) link is 5 ms, and every two eSCO Intervals are equal to three isochronous (ISO) Intervals. The offset (Offset) of a start point of the CIG link for every three ISO Intervals relative to the start point of the eSCO link for every two eSCO Intervals is 740 μs (a range of 600 μs to 800 μs is also acceptable). In the diagram: “HFP” represents the time axis of the CBT eSCO link, and “TMAP” represents the time axis of the BLE CIG link; “C1” denotes the airtime for the CBT central device to transmit 2EV3 packets (corresponding to the time for the CBT peripheral device to receive 2EV3 packets); “P1” denotes the airtime for the CBT peripheral device to transmit 2EV3 packets (corresponding to the time for the CBT central device to receive 2EV3 packets); “c1” denotes the airtime for the CBT central device to transmit 1-slot ACL packets; “p1” denotes the airtime for the CBT peripheral device to transmit 1-slot ACL packets; “C2” denotes the airtime for the BLE central device to transmit CIS PDUs (corresponding to the time for the BLE peripheral device to receive CIS PDUs); “P2” denotes the airtime for the BLE peripheral device to transmit CIS PDUs (corresponding to the time for the BLE central device to receive CIS PDUs); solid lines represent mandatory transmission/reception time, and dashed lines represent retransmission time slots or optional transmission/reception time.

It can be seen from the time coexistence relationship diagram of the TMAP and HFP applications shown in FIG. 3 that when the BLE link and the CBT link of the SDSWA headset adopt frequency division multiplexing (FDM): by configuring the clocks of the BLE link and CBT link to be the same or synchronized, and ensuring that the transmission time of the BLE link does not overlap with the reception time of the CBT link, and the transmission time of the CBT link does not overlap with the reception time of the BLE link, interference between the transmission of one link and the reception of the other (i.e., mutual interference between the two links) can be avoided. Thus, synchronized transmission of dual-source wireless audio is achievable.

According to one embodiment of the present disclosure, an audio device is provided, which is used for implementing the aforementioned synchronized transmission method for dual-source wireless audio. The audio device comprises a host processor and a plurality of controllers. A first controller among the plurality of controllers establishes a first communication link with a first audio source device to perform audio data transmission for a first audio stream with the first audio source device based on the first communication link; a second controller among the plurality of controllers further establishes a second communication link with a second audio source device to perform audio data transmission for a second audio stream with the second audio source device based on the second communication link.

When the audio data transmission on the first communication link and the audio data transmission on the second communication link coexist, the transmission time of either of the first communication link and the second communication link does not overlap with the reception time of the other, and frequency division multiplexing (FDM) is adopted between the first communication link and the second communication link.

For example, the structure of the audio device is as shown in FIG. 1, which is composed of an Application & Host Processor and a Scalable Controller. The Scalable Controller consists of a plurality of controllers (e.g., the first controller and the second controller).

In one optional embodiment: the host processor is connected to the plurality of controllers respectively; or the plurality of controllers are connected in series, and one controller among the plurality of controllers connected in series is connected to the host processor.

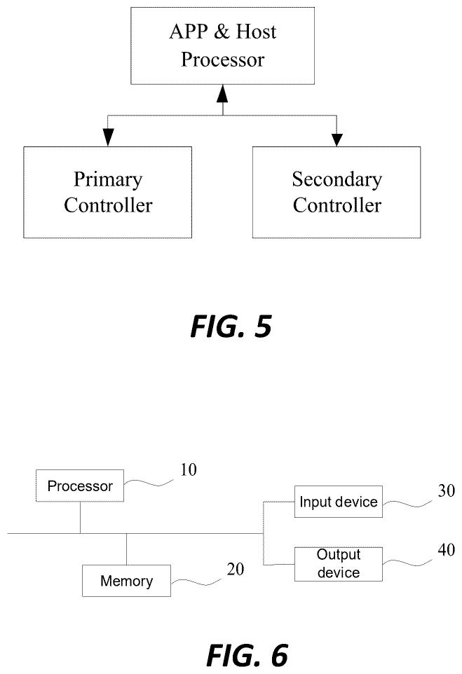

The Application & Host Processor can connect the primary controller and secondary controllers in two ways: series connection and parallel connection. The series connection is shown in FIG. 4, and the parallel connection is shown in FIG. 5.

In one optional embodiment, the controllers are controllers defined by a Bluetooth Core Specification. The primary controller comprises a Host-Controller Interface (HCl) defined by the Bluetooth Core Specification, which is used to connect to the host processor. The primary controller and the secondary controller further comprise physical interfaces that can be used for cascading with each other.

The Host-Controller Interface (HCl) defined by the Classic Bluetooth (CBT) or Bluetooth Low Energy (BLE) Core Specification is adopted between the Application & Host Processor and the Scalable Controller. The physical interface of the HCl may be UART, USB, SDIO, or the like. In the series connection mode, a logical interface between the primary controller and the secondary controller is similar to the HCl, and the physical interface of the HCl may be UART, USB, SDIO, or the like.

Without loss of generality, the controller refers to a “Controller” defined by the Bluetooth (BT) Core Specification, which comprises functions such as Radio, Baseband, Link Controller, Link Manager or Link Layer, and HCl interface. The Application & Host Processor is a collection of all functional modules of the Dual-Source Wireless Audio (DSWA) terminal device except the controller. In addition to executing the Host protocol defined by the CBT or BLE Core Specification, it also executes Profile protocols, application functions, audio encoding/decoding, audio algorithms, and audio input/output.

In one optional embodiment, the primary controller and at least one secondary controller are encapsulated in a single chip. An antenna of the primary controller and an antenna of the at least one secondary controller are distributed at a specified distance from each other; or the primary controller and the at least one secondary controller share the same antenna.

The primary controller and the secondary controller may use independent antennas respectively, or share the same antenna.

A computer device is provided according to one embodiment of the present disclosure. Please refer to FIG. 6, which is a schematic diagram of the hardware structure of a computer device according to one optional embodiment of the present disclosure. As shown in FIG. 6, the computer device comprises: one or more processors 10, a memory 20, and interfaces for connecting various components (including high-speed interfaces and low-speed interfaces). The various components are communicatively connected to each other using different buses, and may be installed on a common motherboard or installed in other manners as required. The processor can process instructions executed in the computer device, including instructions stored in or on the memory to display graphical information of a Graphical User Interface (GUI) on an external input/output device (e.g., a display device coupled to the interface). In some optional embodiments, if necessary, multiple processors and/or multiple buses may be used together with multiple memories. Similarly, multiple computer devices may be connected, with each device providing part of the necessary operations (e.g., as a server array, a group of blade servers, or a multi-processor system). FIG. 6 uses one processor 10 as an example.

The processor 10 may be a Central Processing Unit (CPU), a Network Processor (NP), or a combination thereof. The processor 10 may further comprise a hardware chip. The aforementioned hardware chip may be an Application-Specific Integrated Circuit (ASIC), a Programmable Logic Device (PLD), or a combination thereof. The aforementioned programmable logic device may be a Complex Programmable Logic Device (CPLD), a Field-Programmable Gate Array (FPGA), a Generic Array Logic (GAL), or any combination thereof.

The memory 20 stores instructions executable by at least one processor 10, so that the at least one processor 10 executes the method shown in the aforementioned embodiments.

The memory 20 may comprise a program storage area and a data storage area. The program storage area may store an operating system and an application program required for at least one function; the data storage area may store data created based on the use of the computer device, etc. In addition, the memory 20 may comprise high-speed random access memory, and may also comprise non-transitory memory, such as at least one magnetic disk storage device, flash memory device, or other non-transitory solid-state storage devices. In some optional embodiments, the memory 20 may optionally comprise memory remotely disposed relative to the processor 10, and these remote memories may be connected to the computer device through a network. Examples of the aforementioned network include, but are not limited to, the Internet, an intranet, a local area network (LAN), a mobile communication network, and combinations thereof.

The memory 20 may comprise volatile memory (e.g., random access memory (RAM)); the memory may also comprise non-volatile memory (e.g., flash memory, a hard disk drive (HDD), or a solid-state drive (SSD)); the memory 20 may further comprise a combination of the aforementioned types of memory.

The computer device further comprises an input device 30 and an output device 40. The processor 10, the memory 20, the input device 30, and the output device 40 may be connected through a bus or in other manners. FIG. 6 uses a bus connection as an example. The input device 30 can receive input digital or character information, and generate key signal input related to user settings and function control of the computer device. Examples of the input device 30 comprise a touch screen, a keypad, a mouse, a trackpad, a touchpad, a pointing stick, one or more mouse buttons, a trackball, a joystick, and the like. The output device 40 may comprise a display device, an auxiliary lighting device (e.g., an LED), a haptic feedback device (e.g., a vibration motor), and the like. The aforementioned display devices include, but are not limited to, liquid crystal displays (LCDs), light-emitting diodes (LEDs), displays, and plasma display panels (PDPs). In some optional embodiments, the display device may be a touch screen.

One embodiment of the present disclosure further provides a computer-readable storage medium. The method according to the embodiments of the present disclosure may be implemented in hardware, firmware, or implemented as computer code that can be recorded in a storage medium, or implemented as computer code that is originally stored in a remote storage medium or a non-transitory machine-readable storage medium and downloaded through a network to be stored in a local storage medium. Thus, the method described herein may be stored as such software processing on a storage medium using a general-purpose computer, a dedicated processor, or programmable or dedicated hardware. The storage medium may be a magnetic disk, an optical disk, a read-only memory (ROM), a random access memory (RAM), a flash memory, a hard disk, a solid-state drive, or the like; further, the storage medium may also comprise a combination of the aforementioned types of memories. It can be understood that a computer, a processor, a microprocessor controller, or programmable hardware comprises a storage component that can store or receive software or computer code. When the software or computer code is accessed and executed by the computer, the processor, or the hardware, the method shown in the aforementioned embodiments is implemented.

The embodiments of the present disclosure are described above in conjunction with the accompanying drawings, but the present disclosure is not limited to the specific embodiments described above, the specific embodiments described above are merely illustrative and not limiting, and the person of ordinary skill in the field of the present disclosure, without departing from the purpose of the application and the scope of protection of the claims, may also make many forms, all of which are under the protection of the present disclosure.

Although preferred embodiments of the present disclosure have been described, additional changes and modifications to these embodiments may be made once the basic creative concepts are known to those skilled in the art. The appended claims are therefore intended to be interpreted to comprise preferred embodiments and all changes and modifications falling within the scope of the present disclosure.

Obviously, a person skilled in the art may make various changes and variations to the application without departing from the spirit and scope of the application. Thus, if these modifications and variations of the present disclosure fall within the scope of the claims and their equivalent technologies, the application is also intended to comprise these changes and variations.

What is claimed is:

1. A synchronized transmission system, comprising:
an audio device, comprising a host processor and a plurality of controllers;
a first audio source device configured for establishing a first communication link with a first controller among the plurality of controllers to perform audio data transmission for a first audio stream with the audio device based on the first communication link; and
a second audio source device configured for establishing a second communication link with a second controller among the plurality of controllers to perform audio data transmission for a second audio stream with the audio device based on the second communication link;
wherein when the audio data transmission on the first communication link and the audio data transmission on the second communication link coexist, frequency division multiplexing is adopted between the first communication link and the second communication link, and a transmission time of either one of the first communication link and the second communication link does not overlap with a reception time of the other of the first communication link and the second communication link.

2. The system according to claim 1, wherein the first audio source device serves as a central device of the first communication link, the audio device serves as a peripheral device of the first communication link, and a first link clock of the first communication link is the same as or synchronized with a local clock of the first audio source device;
the second audio source device serves as a peripheral device of the second communication link, the audio device serves as a central device of the second communication link, and a second link clock of the second communication link is the same as or synchronized with the first link clock.

3. The system according to claim 2, wherein when the second audio source device serves as the peripheral device of the second communication link, a local clock of the second audio source device is adjusted based on the second link clock of the second communication link, such that the adjusted local clock of the second audio source device is the same as or synchronized with the second link clock;
the second audio source device is provided with an asynchronous Sampling Rate converter (ASRC), configured to synchronize a sampling rate of audio data input to the second audio source device with the adjusted local clock of the second audio source device.

4. A synchronized transmission method, applied to an audio device comprising a host processor and a plurality of controllers, comprising:
establishing a first communication link with a first audio source device using a first controller among the plurality of controllers, and performing audio data transmission for a first audio stream with the first audio source device based on the first communication link; and
establishing a second communication link with a second audio source device using a second controller among the plurality of controllers, and performing audio data transmission for a second audio stream with the second audio source device based on the second communication link;
wherein when the audio data transmission on the first communication link and the audio data transmission on the second communication link coexist, frequency division multiplexing is adopted between the first communication link and the second communication link, and a transmission time of either one of the first communication link and the second communication link does not overlap with a reception time of the other of the first communication link and the second communication link.

5. The method according to claim 4, wherein
the first audio source device serves as a central device of the first communication link, the audio device serves as a peripheral device of the first communication link, and a first link clock of the first communication link is the same as or synchronized with a local clock of the first audio source device;
the second audio source device serves as a peripheral device of the second communication link, the audio device serves as a central device of the second communication link, and a second link clock of the second communication link is the same as or synchronized with the first link clock.

6. The method according to claim 5, further comprising:
acquiring the first link clock of the first communication link, and adjusting a local clock adopted by the first controller based on the first link clock, so that the adjusted local clock adopted by the first controller is the same as or synchronized with the first link clock when communicating with the first audio source device; and
establishing or maintaining the second link clock of the second communication link according to the adjusted local clock adopted by the first controller, so that the second link clock is the same as or synchronized with the adjusted local clock adopted by the first controller when communicating with the second audio source device.

7. The method according to claim 6, wherein the establishing or maintaining the second link clock of the second communication link according to the adjusted local clock adopted by the first controller, so that the second link clock is the same as or synchronized with the adjusted local clock adopted by the first controller when communicating with the second audio source device, comprises:
adjusting a local clock adopted by the second controller according to the adjusted local clock adopted by the first controller, so that the adjusted local clock adopted by the second controller is the same as or synchronized with the adjusted local clock adopted by the first controller, and establishing or maintaining the second link clock of the second communication link according to the adjusted local clock adopted by the second controller; or,
the first controller and the second controller adopt the same local clock, and the second controller establishes or maintains the second link clock of the second communication link according to the adjusted local clock.

8. The method according to claim 4, wherein the first communication link is a Classic Bluetooth (CBT) link, and the second communication link uses a different link protocol than the first communication link.

9. The method according to claim 8, wherein the second communication link is a Bluetooth Low Energy (BLE) link.

10. The method according to claim 9, wherein the CBT link is a CBT Extended Synchronous Connection-Oriented (eSCO) link, and uses a 2EV3 packet type;
the BLE link is a BLE Connected Isochronous Group (CIG) link, a sub-event interval of the BLE CIG link is equal to 1.25 ms, and an airtime occupied for transmitting one audio data packet is less than 858 μs.

11. An audio device, comprising:
a host processor;
a first controller configured for establishing a first communication link with a first audio source device, so as to perform audio data transmission for a first audio stream with the first audio source device based on the first communication link; and
a second controller configured for establishing a second communication link with a second audio source device, so as to perform audio data transmission for a second audio stream with the second audio source device based on the second communication link;
wherein when the audio data transmission on the first communication link and the audio data transmission on the second communication link coexist, frequency division multiplexing is adopted between the first communication link and the second communication link, and a transmission time of either one of the first communication link and the second communication link does not overlap with a reception time of the other of the first communication link and the second communication link.

12. The device according to claim 11, wherein the audio device comprises a plurality of controllers comprising the first controller and the second controller,
the host processor is respectively connected to the plurality of controllers; or, the plurality of controllers are connected in series, and are connected to the host processor through one controller among the plurality of controllers connected in series.

13. The device according to claim 12, wherein the plurality of controllers comprise one primary controller and at least one secondary controller; the host processor is respectively connected to the primary controller and the at least one secondary controller; or, the primary controller is connected in series with the at least one secondary controller, and the primary controller is connected to the host processor.

14. The device according to claim 13, wherein the controllers are controllers defined by a Bluetooth Core Specification; the primary controller comprises a host-controller interface (HCl) defined by the Bluetooth Core Specification, which is used for connecting to the host processor; the primary controller and the secondary controller further comprise physical interfaces configured to be cascaded with each other.

15. The device according to claim 14, wherein the primary controller and the at least one secondary controller are encapsulated in a single chip;
an antenna of the primary controller and an antenna of the at least one secondary controller are distanced from each other by a specified distance; or, the primary controller and the at least one secondary controller share the same antenna.
